(19) United States
(12) Patent Application Publication
(10) Pub. No.: US 2024/0264902 A1
(43) Pub. Date: Aug. 8, 2024

(54) DATA ENCODING METHOD AND APPARATUS, DEVICE, AND MEDIUM

(71) Applicant: SUZHOU METABRAIN INTELLIGENT TECHNOLOGY CO., LTD., Suzhou, Jiangsu (CN)

(72) Inventors: Ruizhen WU, Suzhou, Jiangsu (CN); Jingjing CHEN, Suzhou, Jiangsu (CN); Yongxing ZHANG, Suzhou, Jiangsu (CN); Xu ZHANG, Suzhou, Jiangsu (CN); Lin WANG, Suzhou, Jiangsu (CN)

(21) Appl. No.: 18/696,394

(22) PCT Filed: Sep. 30, 2022
(86) PCT No.: PCT/CN2022/123401

§ 371 Date: Mar. 28, 2024

(30) Foreign Application Priority Data
Feb. 9, 2022 (CN) 202210119841.9

(51) Int. Cl. G06F 11/10

(52) U.S. Cl. CPC G06F 11/1004

(57) ABSTRACT

The present disclosure discloses a data encoding method and apparatus, a device and a medium. The data encoding method includes: obtaining a storage erasure structure determined based on an original encoding method, wherein the storage erasure structure includes a first preset number of hard disks and a second preset number of stripes, and the hard disks include data disks and check disks; grouping the second preset number of stripes in the storage erasure structure based on a first division rule to obtain different stripe groups, and grouping the data disks corresponding to different stripes in each of the stripe groups based on a second division rule to obtain different data disk groups; and updating check blocks to be updated based on the different stripe groups and the different data disk groups and according to a preset encoding rule to complete data encoding. According to the present disclosure, by improving the original encoding method, the amount of data needed to be read during decoding can be reduced, and the decoding speed can be further greatly improved.

### CROSS-REFERENCE TO RELATED APPLICATION

The present disclosure claims the priority of Chinese patent application filed on Feb. 9, 2022 before the CNIPA, China National Intellectual Property Administration with the application number of 202210119841.9, and the title of “DATA ENCODING METHOD, APPARATUS, DEVICE AND MEDIUM”, which is incorporated herein in its entirety by reference.

### FIELD

The present disclosure relates to the field of data storage technologies, and more particularly to a data encoding method and apparatus, a device and a medium.

### BACKGROUND

With the rapid development of communication technologies and network technologies, digital information is exploding exponentially, and data storage technologies are facing great challenges. People pay more and more attention to problems such as the reliability of data in storage systems and the energy consumption of the storage systems. Nowadays, faced with such a huge data scale, the reliability of data in the storage systems is inversely proportional to the number of components contained in the storage systems, that is, the more components in the storage systems, the lower the reliability of data in the storage systems. According to relevant surveys, in an Internet data center composed of 600 disks, about 30 disks will be damaged every month. In large-scale storage systems, the decline of the reliability of data caused by disk failure is a very serious problem, and people have carried out research on related fault-tolerant technologies. Erasure coding (EC) is a kind of method for data protection, it divides data into segments, extends and encodes redundant data blocks and restores them to different locations, such as disks, storage nodes, or other geographical locations. Original data is divided into k data blocks, m encoding blocks are generated according to an encoding matrix, and then n(n=k+m) blocks are distributed to different servers. When there is an error in data not larger than m blocks, only k blocks are needed to recover the original data.

In today's environment, a wide-stripe erasure is a relatively clear application requirement. A wide stripe in the wide-stripe erasure means that the number of data and verified stripes in the erasure is relatively large. In this case, the security of data can be greatly improved, and the demand probability of checking hard disks can be reduced. However, in the case of the wide-stripe erasure, when using existing erasure algorithms to recover the data, the amount of data that needs to be extracted is too large. At present, input/output operations per second (IOPS) of the hard disks is a main limitation of a storage speed, and thus when the amount of data is relatively large, a speed of data reading will slow down, resulting in a relatively slow speed of data recovery.

### SUMMARY

In view of the above, an object of the present disclosure is to provide a data encoding method and apparatus, a device and a medium, which can reduce the amount of data needed to be read during data recovery and improve the speed of the data recovery in a scene of the wide-stripe erasure. The solutions are as follows.

In a first aspect, the present disclosure discloses a data encoding method, including:
obtaining a storage erasure structure determined based on an original encoding method, wherein the storage erasure structure includes a first preset number of hard disks and a second preset number of stripes, and the hard disks include data disks and check disks;
grouping the second preset number of stripes in the storage erasure structure based on a first division rule to obtain different stripe groups, and grouping the data disks corresponding to different stripes in each of the stripe groups based on a second division rule to obtain different data disk groups; and
updating check blocks to be updated based on the different stripe groups and the different data disk groups and according to a preset encoding rule to complete data encoding.

In some embodiments, the data encoding method further includes:
determining corresponding relationships between the stripes with the data disks and the check disks based on the storage erasure structure.

In some embodiments, grouping the second preset number of stripes in the storage erasure structure based on the first division rule to obtain different stripe groups includes:
determining the first division rule according to the second preset number of the stripes.

In some embodiments, grouping the second preset number of stripes in the storage erasure structure based on the first division rule to obtain different stripe groups includes:
dividing each of the hard disks based on the second preset number of stripes, and grouping the second preset number of stripes based on the first division rule to obtain different stripe groups.

In some embodiments, grouping the second preset number of stripes in the storage erasure structure based on the first division rule to obtain different stripe groups includes:
dividing every two stripes in the storage erasure structure into a group to obtain different stripe groups.

In some embodiments, grouping the second preset number of stripes in the storage erasure structure based on the first division rule to obtain different stripe groups further includes:
dividing every two stripes in the storage erasure structure into a group, grouping a remaining stripe in the storage erasure structure into a group to obtain different stripe groups, and performing encoding on the stripe group including the remaining stripe using the original encoding method.

In some embodiments, encoding the stripe group including the remaining stripe using the original encoding method includes:
not performing re-encoding on the stripe group including the remaining stripe, and performing encoding on the stripe group including the remaining stripe according to the original encoding method.

In some embodiments, grouping the data disks corresponding to different stripes in each of the stripe groups based on a second division rule to obtain different data disk groups includes:
determining a number of data blocks and a number of check blocks to be updated corresponding to different stripes in each of the stripe groups;
calculating a ratio of the number of data blocks to the number of check blocks to be updated, and in response to the ratio not being an integer, treating the ratio by using a ceiling function; and
grouping the data disks corresponding to different stripes in each of the stripe groups by taking the ratio as a division length, and in response to a number of undivided data disks corresponding to different stripes in each of the stripe groups being less than the division length, dividing the undivided data disks into a group to obtain different data disk groups.

In some embodiments, the data encoding method further includes: determining a check disk from the check disks based on a preset operation principle, performing encoding on check blocks in the check disk using the original encoding method, and determining check blocks in remaining check disks in the check disks as the check blocks to be updated.

In some embodiments, the preset operation principle is a simplest operation principle.

In some embodiments, updating check blocks to be updated based on the different stripe groups and the different data disk groups and according to the preset encoding rule includes:
sequencing each of the data disk groups and the check blocks to be updated respectively; and
in each of the stripe groups, after determining serial numbers of the check blocks to be updated, updating check blocks to be updated in check disks corresponding to even stripes in the stripe group using check blocks to be updated in the check disks corresponding to the even stripes in the stripe group.

In some embodiments, updating check blocks to be updated based on the different stripe groups and the different data disk groups and according to the preset encoding rule includes:
sequencing each of the data disk groups and the check blocks to be updated respectively; and
in each of the stripe groups, after determining serial numbers of the check blocks to be updated, updating check blocks to be updated in check disks corresponding to even stripes in the stripe group using data blocks in data disks corresponding to odd stripes in the stripe group, wherein the data blocks have the same serial numbers as the check blocks to be updated.

In some embodiments, updating check blocks to be updated based on the different stripe groups and the different data disk groups and according to the preset encoding rule includes:
sequencing each of the data disk groups and the check blocks to be updated respectively; and
in each of the stripe groups, after determining serial numbers of the check blocks to be updated, updating check blocks to be updated in check disks corresponding to odd stripes in the stripe group using check blocks to be updated in the check disks corresponding to the odd stripes in the stripe group.

In some embodiments, updating check blocks to be updated based on the different stripe groups and the different data disk groups and according to the preset encoding rule includes:
sequencing each of the data disk groups and the check blocks to be updated respectively; and
in each of the stripe groups, after determining serial numbers of the check blocks to be updated, updating check blocks to be updated in check disks corresponding to odd stripes in the stripe group using data blocks in data disks corresponding to even stripes in the stripe group, wherein the data blocks have the same serial numbers as the check blocks to be updated.

In some embodiments, each of the stripes has a corresponding original data block when updating the check blocks to be updated according to the preset encoding rule.

In a second aspect, the present disclosure discloses a data encoding apparatus, including:
an erasure structure obtaining module configured to obtain a storage erasure structure determined based on an original encoding method, wherein the storage erasure structure includes a first preset number of hard disks and a second preset number of stripes, and the hard disks include data disks and check disks;
a grouping module configured to group the second preset number of stripes in the storage erasure structure based on a first division rule to obtain different stripe groups, and group the data disks corresponding to different stripes in each of the stripe groups based on a second division rule to obtain different data disk groups; and
an updating module configured to update check blocks to be updated based on the different stripe groups and the different data disk groups and according to a preset encoding rule to complete data encoding.

In a third aspect, the present disclosure discloses an electronic device, including:
a memory for storing computer programs; and
a processor for executing the computer programs to implement the data encoding method disclosed above.

In a fourth aspect, the present disclosure discloses a non-transitory readable storage medium storing computer programs, wherein the computer programs, when executed by a processor, cause the processor to perform the data encoding method disclosed above.

In a fifth aspect, the present disclosure discloses a computing and processing device, including:
a memory storing computer-readable codes; and
one or more processors, wherein when the computer-readable codes are executed by the one or more processors, the computing and processing device performs the steps of the data encoding method disclosed above.

In a sixth aspect, the present disclosure discloses a computer program product including computer-readable codes, wherein the computer-readable codes, when the computer-readable codes are executed on a computing and processing device, cause the computing and processing device to perform the steps of the data encoding method disclosed above.

It can be seen that the data encoding method provided by the present disclosure includes: obtaining a storage erasure structure determined based on an original encoding method, wherein the storage erasure structure includes a first preset number of hard disks and a second preset number of stripes, and the hard disks include data disks and check disks; grouping the second preset number of stripes in the storage erasure structure based on a first division rule to obtain different stripe groups, and grouping the data disks corresponding to different stripes in each of the stripe groups based on a second division rule to obtain different data disk groups; and updating check blocks to be updated based on the different stripe groups and the different data disk groups and according to a preset encoding rule to complete data encoding. According to the present disclosure, by improving the original encoding method, when decoding based on the improved encoding method, the amount of data needed to be read during decoding can be reduced, and the decoding speed can be further greatly improved.

### BRIEF DESCRIPTION OF THE DRAWINGS

In order to more clearly illustrate the technical solutions of the embodiments of the present disclosure or the prior art, the figures that are required to describe the embodiments or the prior art will be briefly described below. Apparently, the figures that are described below are merely embodiments of the present disclosure, and a person skilled in the art can obtain other figures according to the provided figures without paying creative work.

FIG. 1 is a flow chart of a data encoding method according to the present disclosure;

FIG. 2 is a flow chart of a specific data encoding method according to the present disclosure;

FIG. 3 is a flow chart of a specific data encoding method according to the present disclosure;

FIG. 4 discloses a schematic structural diagram of an erasure coding encoding structure based on an original encoding method;

FIG. 5 discloses an original storage erasure structure with four stripes per disk in a case of K=5 and R=4;

FIG. 6 is an improved storage erasure structure with four stripes per disk in a case of K=5 and R=4 according to the present disclosure;

FIG. 7 is a schematic structural diagram of an encoding hardware according to the present disclosure;

FIG. 8 is a schematic structural diagram of a data encoding apparatus according to the present disclosure;

FIG. 9 is a structural diagram of an electronic device according to the present disclosure;

FIG. 10 schematically illustrates a block diagram of a computing and processing device for executing the method according to the present disclosure; and

FIG. 11 schematically illustrates a memory cell for maintaining or carrying program codes for implementing the method according to the present disclosure.

### DETAILED DESCRIPTION

The technical solutions of the embodiments of the present disclosure will be clearly and completely described below with reference to the drawings of the embodiments of the present disclosure. Apparently, the described embodiments are merely certain embodiments of the present disclosure, rather than all of the embodiments. All of the other embodiments that a person skilled in the art obtains based on the embodiments of the present disclosure without paying creative work fall within the protection scope of the present disclosure.

In the case of a wide-stripe erasure, when using existing erasure algorithms to recover the data, the amount of data that needs to be extracted is too large. At present, input/output operations per second (IOPS) of the hard disks is a main limitation of a storage speed, and thus when the amount of data is relatively large, a speed of data reading will slow down, resulting in a relatively slow speed of data recovery.

Therefore, the embodiment of the present disclosure provides a data encoding method, which can reduce the amount of data needed to be read during data recovery and improve the speed of the data recovery in a scene of the wide-stripe erasure.

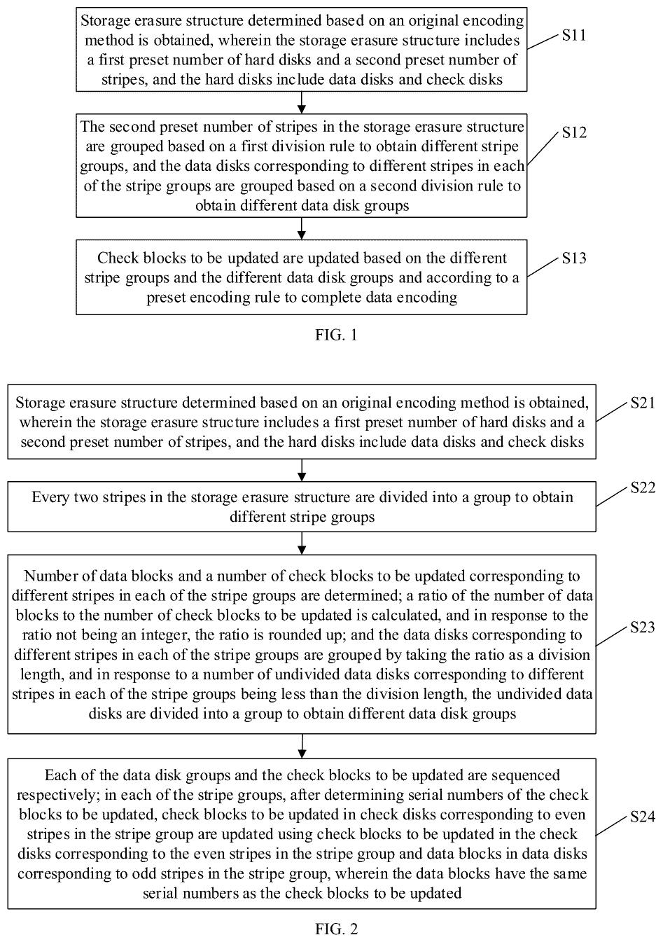

The embodiment of the present disclosure discloses a data encoding method. As shown in FIG. 1, the method includes the following steps.

Step 511, a storage erasure structure determined based on an original encoding method is obtained, wherein the storage erasure structure includes a first preset number of hard disks and a second preset number of stripes, and the hard disks include data disks and check disks.

In this embodiment, firstly, a storage erasure structure determined based on an original encoding method can be obtained, and corresponding relationships between the stripes with the data disks and the check disks can be intuitively seen through the storage erasure structure. The storage erasure structure includes a first preset number of hard disks and a second preset number of stripes, the hard disks include data disks and check disks, the data disks are used for storing data blocks and the check disks are used for storing check blocks.

Step S12, the second preset number of stripes in the storage erasure structure are grouped based on a first division rule to obtain different stripe groups, and the data disks corresponding to different stripes in each of the stripe groups are grouped based on a second division rule to obtain different data disk groups.

In this embodiment, firstly, a storage capacity of the hard disks is divided based on the stripes, each of the hard disks is divided based on the second preset number of stripes; and then the second preset number of stripes in the storage erasure structure are grouped based on a first division rule to obtain different stripe groups, and the data disks corresponding to different stripes in each of the stripe groups are grouped based on a second division rule to obtain different data disk groups.

Step S13, check blocks to be updated are updated based on the different stripe groups and the different data disk groups and according to a preset encoding rule to complete data encoding.

In this embodiment, after obtaining the different stripe groups and the different data disk groups, check blocks to be updated are updated based on the different stripe groups and the different data disk groups and according to a preset encoding rule to complete data encoding.

It should be pointed out that in this embodiment, the process of determining the check blocks to be updated is: determining a check disk from the check disks based on a preset operation principle, performing encoding on check blocks in the check disk using the original encoding method, and then determining check blocks in remaining check disks in the check disks as the check blocks to be updated. In this embodiment, the preset operation principle refers to the simplest operation principle, that is, the check blocks to be updated are determined based on the principle that the whole operation process can be simplified.

It can be seen that the data encoding method provided by the present disclosure includes: obtaining a storage erasure structure determined based on an original encoding method, wherein the storage erasure structure includes a first preset number of hard disks and a second preset number of stripes, and the hard disks include data disks and check disks; grouping the second preset number of stripes in the storage erasure structure based on a first division rule to obtain different stripe groups, and grouping the data disks corresponding to different stripes in each of the stripe groups based on a second division rule to obtain different data disk groups; and updating check blocks to be updated based on the different stripe groups and the different data disk groups and according to a preset encoding rule to complete data encoding. According to the present disclosure, by improving the original encoding method, when decoding based on the improved encoding method, the amount of data needed to be read during decoding can be reduced, and the decoding speed can be further greatly improved.

The embodiment of the present disclosure discloses a data encoding method. As shown in FIG. 2, the method includes the following steps.

Step S21, a storage erasure structure determined based on an original encoding method is obtained, wherein the storage erasure structure includes a first preset number of hard disks and a second preset number of stripes, and the hard disks include data disks and check disks.

For more specific working processes of the above steps, refer to the previously disclosed embodiments, which will not be repeated redundantly herein.

Step S22, every two stripes in the storage erasure structure are divided into a group to obtain different stripe groups.

In this embodiment, when grouping the stripes, it is necessary to define a grouping rule according to a number of stripes. The number of stripes is a second preset number, and when the second preset number is an even number, every two stripes in the storage erasure structure are divided into a group to obtain different stripe groups; in addition, when the second preset number is an odd number, every two stripes in the storage erasure structure are divided into a group, a remaining stripe in the storage erasure structure is grouped into a group to obtain different stripe groups, and encoding is performed on the stripe group including the remaining stripe using the original encoding method. It should be pointed out that performing encoding on the stripe group including the remaining stripe using the original encoding method means that not performing re-encoding on the stripe group including the remaining stripe, and performing encoding on the stripe group including the remaining stripe according to the original encoding method.

Step S23, a number of data blocks and a number of check blocks to be updated corresponding to different stripes in each of the stripe groups are determined; a ratio of the number of data blocks to the number of check blocks to be updated is calculated, and in response to the ratio not being an integer, the ratio is rounded up; and the data disks corresponding to different stripes in each of the stripe groups are grouped by taking the ratio as a division length, and in response to a number of undivided data disks corresponding to different stripes in each of the stripe groups being less than the division length, the undivided data disks are divided into a group to obtain different data disk groups.

In this embodiment, after obtaining the different stripe groups, the data disks corresponding to different stripes in each of the stripe groups are grouped based on a second division rule to obtain different data disk groups. A number of data blocks and a number of check blocks to be updated corresponding to different stripes in each of the stripe groups are determined; a ratio of the number of data blocks to the number of check blocks to be updated is calculated, and in response to the ratio not being an integer, the ratio is rounded up; and the data disks corresponding to different stripes in each of the stripe groups are grouped by taking the ratio as a division length, and in response to a number of undivided data disks corresponding to different stripes in each of the stripe groups being less than the division length, the undivided data disks are divided into a group to obtain different data disk groups.

Step S24, each of the data disk groups and the check blocks to be updated are sequenced respectively; in each of the stripe groups, after determining serial numbers of the check blocks to be updated, check blocks to be updated in check disks corresponding to even stripes in the stripe group are updated using check blocks to be updated in the check disks corresponding to the even stripes in the stripe group and data blocks in data disks corresponding to odd stripes in the stripe group, wherein the data blocks have the same serial numbers as the check blocks to be updated.

In this embodiment, after obtaining the different stripe groups and the different data disk groups, check blocks to be updated are updated based on the different stripe groups and the different data disk groups and according to a preset encoding rule to complete data encoding. Each of the data disk groups and the check blocks to be updated are sequenced respectively; in each of the stripe groups, after determining serial numbers of the check blocks to be updated, check blocks to be updated in check disks corresponding to even stripes in the stripe group are updated using check blocks to be updated in the check disks corresponding to the even stripes in the stripe group and data blocks in data disks corresponding to odd stripes in the stripe group, wherein the data blocks have the same serial numbers as the check blocks to be updated.

It can be seen that the data encoding method provided by the present disclosure includes: obtaining a storage erasure structure determined based on an original encoding method, wherein the storage erasure structure includes a first preset number of hard disks and a second preset number of stripes, and the hard disks include data disks and check disks; determining a number of data blocks and a number of check blocks to be updated corresponding to different stripes in each of the stripe groups; calculating a ratio of the number of data blocks to the number of check blocks to be updated, and in response to the ratio not being an integer, treating the ratio by using a ceiling function; grouping the data disks corresponding to different stripes in each of the stripe groups by taking the ratio as a division length, and in response to a number of undivided data disks corresponding to different stripes in each of the stripe groups being less than the division length, dividing the undivided data disks into a group to obtain different data disk groups; sequencing each of the data disk groups and the check blocks to be updated respectively; and in each of the stripe groups, after determining serial numbers of the check blocks to be updated, updating check blocks to be updated in check disks corresponding to even stripes in the stripe group using check blocks to be updated in the check disks corresponding to the even stripes in the stripe group and data blocks in data disks corresponding to odd stripes in the stripe group, wherein the data blocks have the same serial numbers as the check blocks to be updated. According to the present disclosure, by improving the original encoding method, when decoding based on the improved encoding method, the amount of data needed to be read during decoding can be reduced, and the decoding speed can be further greatly improved.

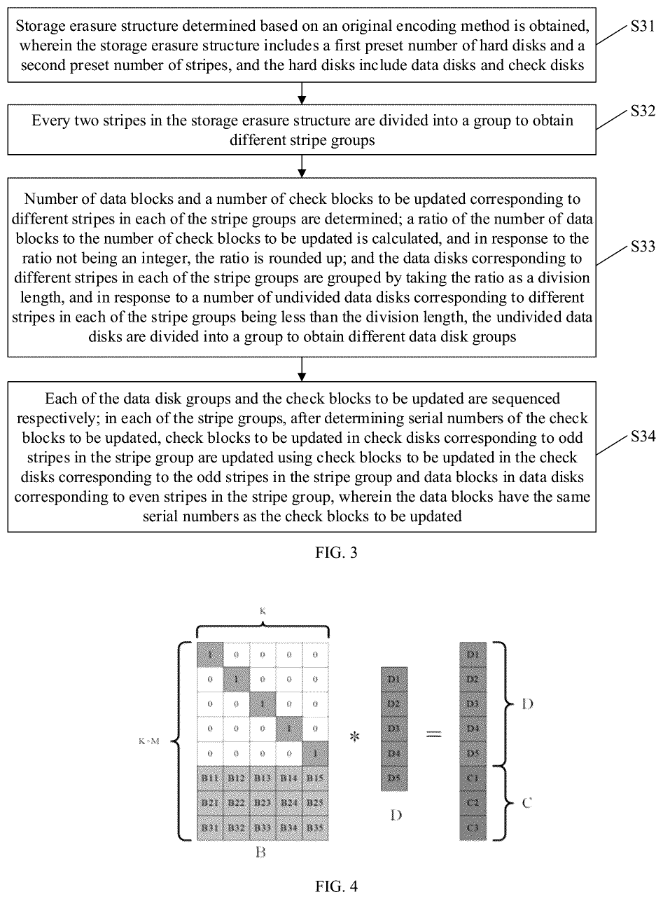

The embodiment of the present disclosure discloses a specific data encoding method. As shown in FIG. 3, the method includes the following steps.

Step S31, a storage erasure structure determined based on an original encoding method is obtained, wherein the storage erasure structure includes a first preset number of hard disks and a second preset number of stripes, and the hard disks include data disks and check disks.

For more specific working processes of the above steps, refer to the previously disclosed embodiments, which will not be repeated redundantly herein.

Step S32, every two stripes in the storage erasure structure are divided into a group to obtain different stripe groups.

In this embodiment, when grouping the stripes, it is necessary to define a grouping rule according to a number of stripes. The number of stripes is a second preset number, and when the second preset number is an even number, every two stripes in the storage erasure structure are divided into a group to obtain different stripe groups; in addition, when the second preset number is an odd number, every two stripes in the storage erasure structure are divided into a group, a remaining stripe in the storage erasure structure is grouped into a group to obtain different stripe groups, and encoding is performed on the stripe group including the remaining stripe using the original encoding method. It should be pointed out that performing encoding on the stripe group including the remaining stripe using the original encoding method means that not performing re-encoding on the stripe group including the remaining stripe, and performing encoding on the stripe group including the remaining stripe according to the original encoding method.

Step S33, a number of data blocks and a number of check blocks to be updated corresponding to different stripes in each of the stripe groups are determined; a ratio of the number of data blocks to the number of check blocks to be updated is calculated, and in response to the ratio not being an integer, the ratio is rounded up; and the data disks corresponding to different stripes in each of the stripe groups are grouped by taking the ratio as a division length, and in response to a number of undivided data disks corresponding to different stripes in each of the stripe groups being less than the division length, the undivided data disks are divided into a group to obtain different data disk groups.

In this embodiment, after obtaining the different stripe groups, the data disks corresponding to different stripes in each of the stripe groups are grouped based on a second division rule to obtain different data disk groups. A number of data blocks and a number of check blocks to be updated corresponding to different stripes in each of the stripe groups are determined; a ratio of the number of data blocks to the number of check blocks to be updated is calculated, and in response to the ratio not being an integer, the ratio is rounded up; and the data disks corresponding to different stripes in each of the stripe groups are grouped by taking the ratio as a division length, and in response to a number of undivided data disks corresponding to different stripes in each of the stripe groups being less than the division length, the undivided data disks are divided into a group to obtain different data disk groups.

Step S34, each of the data disk groups and the check blocks to be updated are sequenced respectively; in each of the stripe groups, after determining serial numbers of the check blocks to be updated, check blocks to be updated in check disks corresponding to odd stripes in the stripe group are updated using check blocks to be updated in the check disks corresponding to the odd stripes in the stripe group and data blocks in data disks corresponding to even stripes in the stripe group, wherein the data blocks have the same serial numbers as the check blocks to be updated.

In this embodiment, after obtaining the different stripe groups and the different data disk groups, check blocks to be updated are updated based on the different stripe groups and the different data disk groups and according to a preset encoding rule to complete data encoding. Each of the data disk groups and the check blocks to be updated are sequenced respectively; in each of the stripe groups, after determining serial numbers of the check blocks to be updated, check blocks to be updated in check disks corresponding to odd stripes in the stripe group are updated using check blocks to be updated in the check disks corresponding to the odd stripes in the stripe group and data blocks in data disks corresponding to even stripes in the stripe group, wherein the data blocks have the same serial numbers as the check blocks to be updated.

It should be pointed out that in this embodiment, in order to obtain the maximum number of errors, when updating the check blocks to be updated according to the preset encoding rule, it is necessary to ensure that one stripe has the original data block. Therefore, according to the above encoding rule, only the check blocks to be updated in the check disks corresponding to the even stripes in the stripe group and data blocks having the same serial numbers as the check blocks to be updated in data disks corresponding to odd stripes in the stripe group can be used to update the check blocks to be updated in check disks corresponding to even stripes in the stripe group, or the check blocks to be updated in the check disks corresponding to the odd stripes in the stripe group and data blocks having the same serial numbers as the check blocks to be updated in data disks corresponding to even stripes in the stripe group can be used to update the check blocks to be updated in check disks corresponding to odd stripes in the stripe group. Two situations cannot exist at the same time.

It can be seen that the data encoding method provided by the present disclosure includes: obtaining a storage erasure structure determined based on an original encoding method, wherein the storage erasure structure includes a first preset number of hard disks and a second preset number of stripes, and the hard disks include data disks and check disks; determining a number of data blocks and a number of check blocks to be updated corresponding to different stripes in each of the stripe groups; calculating a ratio of the number of data blocks to the number of check blocks to be updated, and in response to the ratio not being an integer, treating the ratio by using a ceiling function; grouping the data disks corresponding to different stripes in each of the stripe groups by taking the ratio as a division length, and in response to a number of undivided data disks corresponding to different stripes in each of the stripe groups being less than the division length, dividing the undivided data disks into a group to obtain different data disk groups; sequencing each of the data disk groups and the check blocks to be updated respectively; and in each of the stripe groups, after determining serial numbers of the check blocks to be updated, updating check blocks to be updated in check disks corresponding to odd stripes in the stripe group using check blocks to be updated in the check disks corresponding to the odd stripes in the stripe group and data blocks in data disks corresponding to even stripes in the stripe group, wherein the data blocks have the same serial numbers as the check blocks to be updated. According to the present disclosure, by improving the original encoding method, when decoding based on the improved encoding method, the amount of data needed to be read during decoding can be reduced, and the decoding speed can be further greatly improved.

FIG. 4 discloses a schematic structural diagram of an erasure coding encoding structure based on an original encoding method.

1. Erasure coding belongs to a forward error correction technology in coding theory, which was first applied in the field of communication to solve the problems of the missing and the loss in data transmission. Due to the good performance of erasure coding technologies in preventing data loss, it has been introduced into the field of storage. Erasure coding can effectively reduce the storage overhead on the premise of ensuring the same reliability, and thus erasure coding technologies are widely used in major storage systems and data centers such as Microsoft's Azure and Facebook's F4. Erasure coding refers to dividing original data into k data blocks, generating m encoding blocks according to an encoding matrix, and then n(n=k+m) blocks are distributed to different servers. When there is an error in data not larger than m blocks, only k blocks are needed to recover the original data. The parameter configuration of erasure coding is as follows.

(1) k: data block. K represents the number of blocks to divide the original data and the minimum number of blocks to recover the original data. The smaller the value of k, the higher the cost of data reconstruction when a fault occurs; and the larger the value of k, the more data copies are needed, thereby increasing loads of the network and IO.

(2) m: encoding block. M affects the reliability and the storage cost of data preservation. The larger the value of m, the greater the tolerance for faults, the greater the redundancy of data, and the higher the storage cost.

(3) n: number of generated blocks (n=k+m).

(4) Effective storage ratio: k/n.

The encoding of the original erasure coding generally uses a Vandermonde matrix or a Cauchy matrix. As shown in FIG. 4, the number of data blocks to be encoded is k=5, an encoding requirement is m=3, parts such as B11 and B12 can be the Vandermonde matrix or the Cauchy matrix, and a code block finally generated is a part D+C, with a total number of k+m=8, and the effective storage ratio is k/n=5/8. Such an erasure system can encode k D to obtain m C. The erasure system can decode and recover any m errors in the system after m encodings are realized.

2. Reed-Solomon Code (RS Code) applied in a distributed environment is common in practical storage systems. The RS Code is related to two parameters k and r. Two positive integers, namely, k and r, are given, and k data blocks are encoded into r additional check blocks by the RS Code. A mode of encoding r check blocks based on a Vandermonde matrix or a Cauchy matrix is called RS erasure coding encoded by using the Vandermonde matrix or the Cauchy matrix. The specific encoding processes of RS erasure coding based on the Vandermonde matrix and RS erasure coding based on the Cauchy matrix may be referred to: K. Rashmi, et al . . . A hitchhiker's guide to fast and efficient data reconstruction in erasure-coded datacenters. In Proc.of.ACM⋅SIGCOMM,⋅2014.

In the above formula, a k*k matrix corresponds to k original data blocks, and an r*k matrix corresponds to an encoding matrix. The encoding matrix is multiplied with the original data D₁ to Dₖ to obtain newly added P₁ to Pᵣ, which are r check data obtained by encoding. When any, at most r, data fails or losses in transmission and needs to be corrected, the original data blocks D₁ to Dₖ will be obtained by multiplying an inverse matrix of a matrix corresponding to remaining data and the data. A process of an example in which data of D₁ to data of Dᵣ loss and are decoded may be referred to: X. Zhang, Y. Hu, . . . Lee, and p. Zhou. Toward optimal storage scaling via network coding. From theory to practice. In⋅Proc.0f IEEEINFOCOM, pages 1808-1816,-2018.

Therefore, a core concept of the erasure coding is to construct an invertible encoding matrix to generate check data, and an inverse matrix thereof can recover the original data through calculation. Common RS erasure coding uses the Cauchy matrix or the Vandermonde matrix introduced above, which has the advantage that the obtained matrix is invertible and any submatrix is also invertible, and the size expansion of the matrix is simple.

Most of existing erasure algorithms uses a RS algorithm, which has the advantages of simple calculation and flexible expansion, and thus the RS algorithm is widely used in industry. The RS algorithm generally adopts Vandermonde algorithm or Cauchy algorithm described above. No matter what algorithm is adopted here, an encoding relationship and a decoding relationship are set as follows:

$$encoding : {p}_{i} = {fe}_{i} ( {d}_{i} ) ;$$

$$decoding : {d}_{i} = {fde}_{i} ( {d}_{i} ) .$$

An example is given of the erasure system constructed using the RS algorithm of standard Vandermonde for encoding and decoding in the case of any wide-stripe erasure with k=5 and r=4. The encoding relationship at this time is as follows:

$$encoding : [ \begin{matrix}1 & 0 & 0 & 0 & 0 \\ 0 & 1 & 0 & 0 & 0 \\ 0 & 0 & 1 & 0 & 0 \\ 0 & 0 & 0 & 1 & 0 \\ 0 & 0 & 0 & 0 & 1 \\ 1 & 1 & 1 & 1 & 1 \\ 1 & 2 & 3 & 4 & 5 \\ 1 & {2}^{2} & {3}^{2} & {4}^{2} & {5}^{2} \\ 1 & {2}^{3} & {3}^{3} & {4}^{3} & {5}^{3}\end{matrix} ] * [ \begin{matrix}{d}_{1} \\ {d}_{2} \\ {d}_{3} \\ {d}_{4} \\ {d}_{5}\end{matrix} ] = [ \begin{matrix}{d}_{1} \\ {d}_{2} \\ {d}_{3} \\ {d}_{4} \\ {d}_{5} \\ {p}_{1} \\ {p}_{2} \\ {p}_{3} \\ {p}_{4}\end{matrix} ] .$$

In the above encoding relationship, Pi is taken as an example in the formula of the above encoding relationship and decoding relationship proposed in the present disclosure:

$$\begin{matrix}{p}_{1} = {fe}_{i} ( {d}_{i} ) \\ = {d}_{1} ⊕ {d}_{2} ⊕ {d}_{3} ⊕ {d}_{4} ⊕ {d}_{5}\end{matrix} .$$

In the same way, the relationship of fde corresponding to decoding can be obtained, where ⊕ is an exclusive OR symbol.

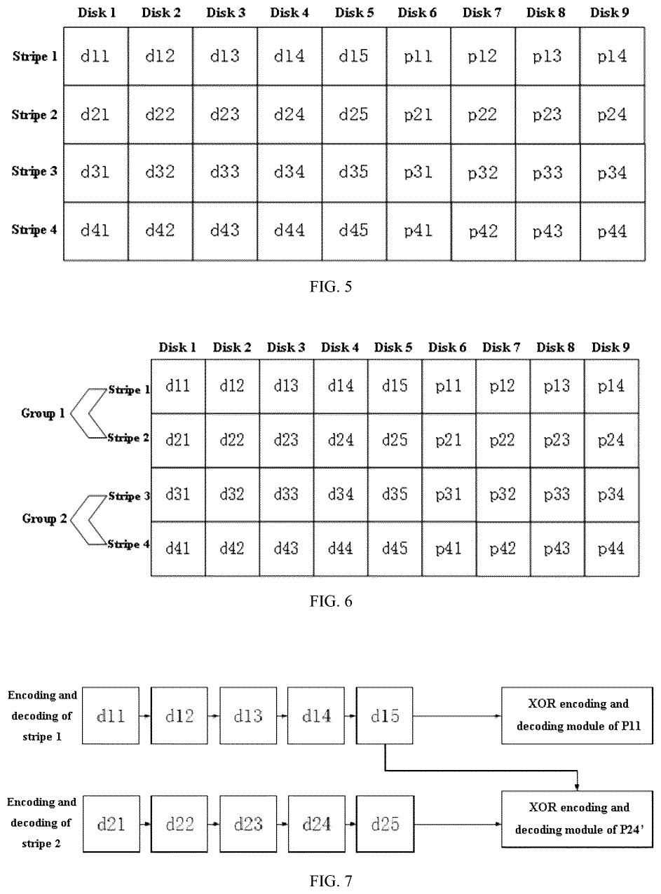

FIG. 5 discloses an original storage erasure structure with four stripes per disk in a case of K=5 and R=4.

Assuming that each hard disk is divided into four stripes, and only a relationship between data and check is considered without considering the load balance, a relationship of the storage erasure structure is shown in FIG. 5. In FIG. 5, p11, p12, p13 and p14 are check data generated using a strip 1 based on a formula of an encoding relationship. Correspondingly, encoding relationships of other strips are the same. In the case of the original encoding, the above encoding can recover 1 to 4 errors from any disk. When an error occurs and the error is a disk 1, the original RS encoding needs to calculate data of a disk 2 to a disk 5 and any one check of a disk 6 to a disk 9 to complete a decoding operation. At this time, the number of data blocks to be taken out is 20.

The present disclosure proposes an algorithm to reduce the amount of data needed for decoding recovery at the expense of encoding complexity. In hardware implementation, since the data read during encoding can be applied to different check blocks in parallel, the actual encoding speed is not affected, and the decoding speed will be greatly improved due to the reduction of reading data.

FIG. 6 is an improved storage erasure structure with four stripes per disk in a case of K=5 and R=4 according to the present disclosure.

The specific implementation process is shown in FIG. 6.

(1) Stripes are grouped based on even numbers. Every two stripe groups are divided into one group.

(2) Data disks are grouped based on the number of check disks. The grouping method is as follows:

$$n = ⌈ \frac{k}{r - 1} ⌉ .$$

When k/(r−1) is indivisible, it is rounded up, so that the number of data disks corresponding to each group is divided into integers based on n. Taking the above situation as an example, k=5 and r=4, and then:

$$n = ⌈ \frac{k}{r - 1} ⌉ = ⌈ \frac{5}{4 - 1} ⌉ = 2.$$

Therefore, each group is divided into integers based on n=2, which are divided into 2, 2 and 1 elements, respectively.

For the above example, it can be arbitrarily divided into a group of the disk 1 and the disk 2, a group of the disk 3 and the disk 4, and a group of the disk 5.

(3) The check of odd numbers (or even numbers) in each group is generated into data disks in the step (2) of adding even numbers (or odd numbers) in the group. Taking FIG. 6 as an example, consider adding odd data disks to even check disks. Taking a group 1 as an example, the grouping is added as follows:

$$p {22}^{′} = p 22 ⊕ d 11 ⊕ d 12 ;$$

$$p {23}^{′} = p 23 ⊕ d 13 ⊕ d 14 ;$$

$$p {24}^{′} = p 24 ⊕ d 15.$$

Similarly, the even stripes in a group 2 are also updated using the data of the odd stripes, and as described above, all encoding can be completed. It should be pointed out that the encoding operation here does not change the original generation mode of RS encoding. For additional XOR data added to the even (or odd) check codes, it is only necessary to send it to updated check blocks for operation when encoding itself.

FIG. 7 is a schematic structural diagram of an encoding hardware according to the present disclosure.

Taking the generation of p24′ as an example, a hardware structure thereof is shown in FIG. 7. It can be seen that an original encoding sequence and mode do not need to be changed. For a newly added part of the check blocks, it is only necessary to directly transfer the data blocks involved in other encoding. The operations here are carried out in parallel, and there is no need to add new data reading and moving, therefore, there is no impact on speed and area.

In the decoding part, when an error occurs in a disk, taking an error in the disk 5 as an example to illustrate. At this time, errors are d15, d25, d35 and d45. First, all eight data blocks of d21-d24 and d41-d44 are read and recovered using p21 and p41, respectively to obtain two data blocks of d25 and d45. Then, p24′ and p44′ are taken out. Based on the above formula of grouping increase, it can be known that d21-d25 and d41-d45 have been obtained at this time, and d15 and d35 can be directly obtained by using the above formula of grouping increase. That is, to complete the recovery of a disk error, only 12 data blocks of d21-d24, d41-d44, p21, p41, p24′ and p44′ need to be taken out from the hard disk. Compared with the original method, which needs to take out 20 data blocks, some data reading requirements can be reduced and the reading speed can be improved to a certain extent. Similarly, when more than one error occurs, there are also different speed increases, which will not be illustrated here. The present disclosure proposes forward a hardware accelerator solution for improving the recovery speed of error correction in the wide-stripe erasure. In view of the fact that the recovery speed of errors is high under the actual needs of users today, and the characteristic that the main reason for limiting the speed of storage erasure structure is the IOPS limitation of data handling, on the premise of the original RS erasure method, the encoding solution is improved, so that when decoding needs occur, the data handling capacity can be reduced to improve the decoding speed.

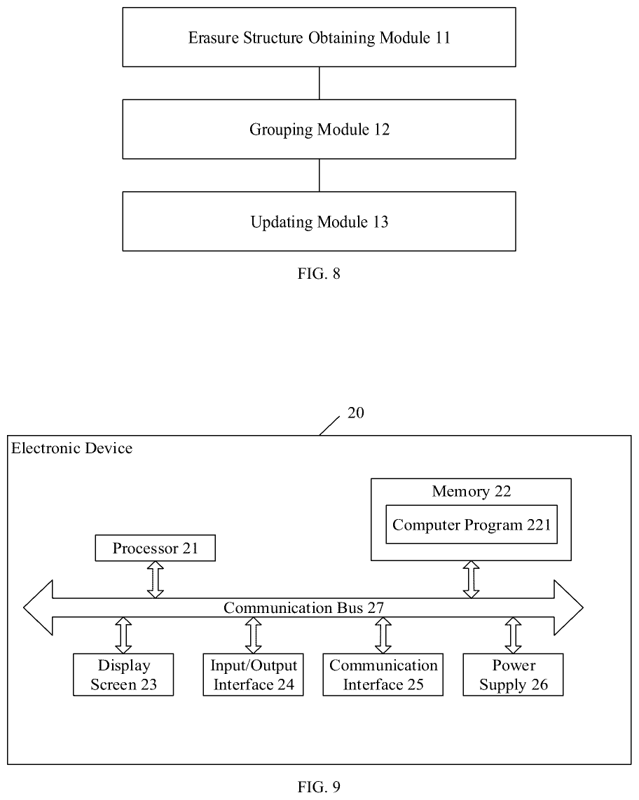

Correspondingly, the embodiment of the present disclosure further discloses a data encoding apparatus. As shown in FIG. 8, the apparatus includes:
an erasure structure obtaining module 11 configured to obtain a storage erasure structure determined based on an original encoding method, wherein the storage erasure structure includes a first preset number of hard disks and a second preset number of stripes, and the hard disks include data disks and check disks;
a grouping module 12 configured to group the second preset number of stripes in the storage erasure structure based on a first division rule to obtain different stripe groups, and group the data disks corresponding to different stripes in each of the stripe groups based on a second division rule to obtain different data disk groups; and
an updating module 13 configured to update check blocks to be updated based on the different stripe groups and the different data disk groups and according to a preset encoding rule to complete data encoding.

For more specific working processes of the above modules, refer to the corresponding contents disclosed in the aforementioned embodiments, which will not be repeated redundantly herein.

It can be seen that the data encoding method provided by the present disclosure includes: obtaining a storage erasure structure determined based on an original encoding method, wherein the storage erasure structure includes a first preset number of hard disks and a second preset number of stripes, and the hard disks include data disks and check disks; grouping the second preset number of stripes in the storage erasure structure based on a first division rule to obtain different stripe groups, and grouping the data disks corresponding to different stripes in each of the stripe groups based on a second division rule to obtain different data disk groups; and updating check blocks to be updated based on the different stripe groups and the different data disk groups and according to a preset encoding rule to complete data encoding. According to the present disclosure, by improving the original encoding method, when decoding based on the improved encoding method, the amount of data needed to be read during decoding can be reduced, and the decoding speed can be further greatly improved.

Further, the embodiment of the present disclosure further provides an electronic device. FIG. 9 is a structural diagram of an electronic device 20 according to an exemplary embodiment, and contents in the figure cannot be considered as any limitation on the scope of use of the present disclosure.

FIG. 9 is a structural diagram of an electronic device 20 according to an embodiment of the present disclosure. The electronic device 20 may include at least one processor 21, at least one memory 22, a display screen 23, an input/output interface 24, a communication interface 25, a power supply 26, and a communication bus 27. The memory 22 is configured to store a computer program, and the computer program is loaded and executed by the processor 21 to implement the relevant steps in the data encoding method disclosed in any of the foregoing embodiments. In addition, the electronic device 20 in this embodiment can be an electronic computer.

In this embodiment, the power supply 26 is configured to provide working voltage for each hardware device on the electronic device 20. The communication interface 25 can create a data transmission channel between the electronic device 20 and a peripheral device, and follows any communication protocol that can be applied to the technical solutions of the present disclosure, which is not specifically limited here. The input/output interface 24 is configured to obtain outside input data or output data to the outside, and a certain interface type can be selected according to an application requirement and will not be specifically limited here.

In addition, the memory 22, as a carrier for resource storage, can be a read-only memory, a random access memory, a magnetic disk, an optical disk, or the like. Resources stored in the memory 22 can include a computer program 221, and a storage manner can be temporary storage or permanent storage. The computer program 221 can further include computer programs that can be used to complete other certain tasks, in addition to the computer program that can be used to complete the data encoding method executed by the electronic device 20 in any of the aforementioned embodiments.

Further, the embodiment of the present disclosure further discloses a non-transitory readable storage medium storing computer programs, wherein the computer programs, when executed by a processor, implement the data encoding method disclosed above.

For specific steps of this method, refer to the corresponding contents disclosed in the aforementioned embodiments, which will not be repeated redundantly herein.

Each of devices according to the embodiments of the present disclosure can be implemented by hardware, or implemented by software modules operating on one or more processors, or implemented by the combination thereof. A person skilled in the art should understand that, in practice, a microprocessor or a digital signal processor (DSP) can be used to realize some or all of the functions of some or all of the modules in the device according to the embodiments of the present disclosure. The present disclosure can further be implemented as device program (for example, computer program and computer program product) for executing some or all of the methods as described herein. Such program for implementing the present disclosure can be stored in the computer readable medium, or have a form of one or more signals. Such a signal can be downloaded from the internet websites, or be provided in carrier, or be provided in other manners.

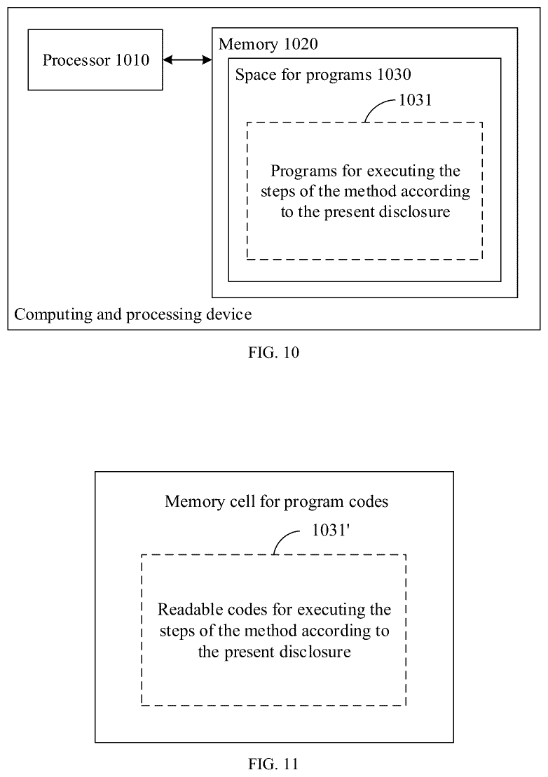

For example, FIG. 10 illustrates a block diagram of a computing and processing device for executing the method according to the present disclosure. The computing and processing device includes a processor 1010 and a computer program product or a computer readable medium in form of a memory 1020. The memory 1020 can be electronic memories such as flash memory, EEPROM (Electrically Erasable Programmable Read-Only Memory), EPROM, hard disk or ROM. The memory 1020 has a memory space 1030 for executing program codes 1031 of any step in the above methods. For example, the memory space 1030 for program codes can include respective program codes 1031 for implementing the respective steps in the method mentioned above. These program codes can be read from and/or be written into one or more computer program products. These computer program products include program code carriers such as hard disks, compact disks (CDs), memory cards or floppy disks. These computer program products are usually the portable or stable memory cells as shown in reference FIG. 11. The memory cells can be provided with memory sections, memory spaces, etc., similar to the memory 1020 of the server as shown in FIG. 10. The program codes can be compressed for example in an appropriate form. Generally, the memory cell includes computer readable codes 1031′ which can be read for example by processors 1010. When these codes are operated on the server, the server can execute respective steps in the method described above.

The various embodiments in the present specification are described in a progressive manner, and each embodiment focuses on differences from other embodiments, and the same or similar parts between the various embodiments can be referred to each other. For the apparatus disclosed in the embodiments, since it corresponds to the method disclosed in the embodiments, the description is relatively simple, and the relevant parts can be referred to the method section.

Professionals can further realize that the units and algorithm steps of each example described in combination with the embodiments disclosed in the embodiments of the present disclosure can be implemented in electronic hardware, computer hardware or a combination of computer software and the electronic hardware. In order to clearly illustrate the interchangeability of hardware and software, the composition and steps of each example have been described in general terms of function in the above description. Whether these functions are executed in a hardware or software manner depends on specific applications and design constraints of the technical solutions. Professionals can realize the described functions for each specific application by use of different methods, but such realization shall fall within the scope of the embodiments of the present disclosure.

The steps of the method or algorithm described with reference to the embodiments disclosed herein can be implemented directly by using hardware, a software module executed by a processor or a combination thereof. The software module can be embedded in a Random Access Memory (RAM), an internal memory, a read-only memory (ROM), an electrically programmable ROM, an electrically erasable programmable ROM, a register, a hard disk, a removable disk, a CD-ROM, or a storage medium in any other form well known in the art.

Finally, it should also be noted that in the present specification, relationship terms such as first and second are merely intended to distinguish one entity or operation from another entity or operation, and do not necessarily require or imply any such actual relationship or order between those entities or operations. Further, the terms “includes”, “comprises” or any other variation thereof are intended to cover non-exclusive inclusion, such that a process, method, article, or device including a series of elements includes not only those elements, but also other elements not expressly listed, or elements that are inherent to such a process, method, article, or device. Without further limitation, the elements defined by the statement “including a . . . ” do not preclude the existence of additional identical elements in the process, method, article, or device that include the elements.

The above is a detailed description of the data encoding method and apparatus, the device and the medium provided by the present disclosure, and the principle and embodiments of the present disclosure are described by applying specific examples in the text. The above description of the embodiments is merely for helping to understand the method of the present disclosure and its core idea. At the same time, for a person skilled in the art, changes can be made in the specific embodiments and application scope according to the idea of the present disclosure. In summary, the content of this specification should not be understood as a limitation of the present disclosure.

1. A data encoding method, comprising:
obtaining a storage erasure structure determined based on an original encoding method, wherein the storage erasure structure comprises a first preset number of hard disks and a second preset number of stripes, and the hard disks comprise data disks and check disks;
grouping the second preset number of stripes in the storage erasure structure based on a first division rule to obtain different stripe groups, and grouping the data disks corresponding to different stripes in each of the stripe groups based on a second division rule to obtain different data disk groups; and
updating check blocks to be updated based on the different stripe groups and the different data disk groups and according to a preset encoding rule to complete data encoding;
wherein grouping the data disks corresponding to different stripes in each of the stripe groups based on a second division rule to obtain different data disk groups comprises:
determining a number of data blocks and a number of check blocks to be updated corresponding to different stripes in each of the stripe groups; calculating a ratio of the number of data blocks to the number of check blocks to be updated, and in response to the ratio not being an integer, treating the ratio by using a ceiling function; and grouping the data disks corresponding to different stripes in each of the stripe groups by taking the ratio as a division length, and in response to a number of undivided data disks corresponding to different stripes in each of the stripe groups being less than the division length, dividing the undivided data disks into a group to obtain different data disk groups.

2. The data encoding method according to claim 1, further comprising:
determining corresponding relationships between the stripes with the data disks and the check disks based on the storage erasure structure.

3. The data encoding method according to claim 1, wherein grouping the second preset number of stripes in the storage erasure structure based on the first division rule to obtain different stripe groups comprises:
determining the first division rule according to the second preset number of the stripes.

4. The data encoding method according to claim 3, wherein grouping the second preset number of stripes in the storage erasure structure based on the first division rule to obtain different stripe groups comprises:
dividing each of the hard disks based on the second preset number of stripes, and grouping the second preset number of stripes based on the first division rule to obtain different stripe groups.

5. The data encoding method according to claim 3, wherein in response to the second preset number being an even number, grouping the second preset number of stripes in the storage erasure structure based on the first division rule to obtain different stripe groups comprises:
dividing every two stripes in the storage erasure structure into a group to obtain different stripe groups.

6. The data encoding method according to claim 1, wherein in response to the second preset number being an odd number, grouping the second preset number of stripes in the storage erasure structure based on the first division rule to obtain different stripe groups further comprises:
dividing every two stripes in the storage erasure structure into a group, grouping a remaining stripe in the storage erasure structure into a group to obtain different stripe groups, and performing encoding on the stripe group including the remaining stripe using the original encoding method.

7. The data encoding method according to claim 6, wherein encoding the stripe group including the remaining stripe using the original encoding method comprises:
not performing re-encoding on the stripe group including the remaining stripe, and performing encoding on the stripe group including the remaining stripe according to the original encoding method.

8. (canceled)

9. The data encoding method according to claim 1, further comprising:
determining a check disk from the check disks based on a preset operation principle, performing encoding on check blocks in the check disk using the original encoding method, and determining check blocks in remaining check disks in the check disks as the check blocks to be updated.

10. The data encoding method according to claim 9, wherein the preset operation principle is a simplest operation principle.

11. The data encoding method according to claim 1, wherein updating check blocks to be updated based on the different stripe groups and the different data disk groups and according to the preset encoding rule comprises:
sequencing each of the data disk groups and the check blocks to be updated respectively; and
in each of the stripe groups, after determining serial numbers of the check blocks to be updated, updating check blocks to be updated in check disks corresponding to even stripes in the stripe group using check blocks to be updated in the check disks corresponding to the even stripes in the stripe group.

12. The data encoding method according to claim 1, wherein updating check blocks to be updated based on the different stripe groups and the different data disk groups and according to the preset encoding rule comprises:
sequencing each of the data disk groups and the check blocks to be updated respectively; and
in each of the stripe groups, after determining serial numbers of the check blocks to be updated, updating check blocks to be updated in check disks corresponding to even stripes in the stripe group using data blocks in data disks corresponding to odd stripes in the stripe group, wherein the data blocks have the same serial numbers as the check blocks to be updated.

13. The data encoding method according to claim 1, wherein updating check blocks to be updated based on the different stripe groups and the different data disk groups and according to the preset encoding rule comprises:
sequencing each of the data disk groups and the check blocks to be updated respectively; and
in each of the stripe groups, after determining serial numbers of the check blocks to be updated, updating check blocks to be updated in check disks corresponding to odd stripes in the stripe group using check blocks to be updated in the check disks corresponding to the odd stripes in the stripe group.

14. The data encoding method according to claim 1, wherein updating check blocks to be updated based on the different stripe groups and the different data disk groups and according to the preset encoding rule comprises:
sequencing each of the data disk groups and the check blocks to be updated respectively; and
in each of the stripe groups, after determining serial numbers of the check blocks to be updated, updating check blocks to be updated in check disks corresponding to odd stripes in the stripe group using data blocks in data disks corresponding to even stripes in the stripe group, wherein the data blocks have the same serial numbers as the check blocks to be updated.

15. The data encoding method according to claim 1, wherein each of the stripes has a corresponding original data block when updating the check blocks to be updated according to the preset encoding rule.

16. (canceled)

17. An electronic device, comprising:
a memory for storing computer programs; and
a processor for executing the computer programs to implement the data encoding method according to claim 1.

18. A non-transitory readable storage medium storing computer programs, wherein the computer programs, when executed by a processor, cause the processor to perform the data encoding method according to claim 1.

19. (canceled)

20. (canceled)

21. The data encoding method according to claim 1, wherein in response to the ratio not being an integer, treating the ratio by using a ceiling function comprises:
calculating the ratio through a following formula, and in response to the ratio not being an integer, treating the ratio by using a ceiling function:
$$n = ⌈ \frac{k}{r - 1} ⌉ ,$$
wherein n represents the ratio, ┌ ┐ represents a rounding up operation, k represents the number of data blocks, and r represents the number of check blocks to be updated.

22. The electronic device according to claim 17, wherein grouping the data disks corresponding to different stripes in each of the stripe groups based on a second division rule to obtain different data disk groups comprises:
determining a number of data blocks and a number of check blocks to be updated corresponding to different stripes in each of the stripe groups;
calculating a ratio of the number of data blocks to the number of check blocks to be updated, and in response to the ratio not being an integer, treating the ratio by using a ceiling function; and
grouping the data disks corresponding to different stripes in each of the stripe groups by taking the ratio as a division length, and in response to a number of undivided data disks corresponding to different stripes in each of the stripe groups being less than the division length, dividing the undivided data disks into a group to obtain different data disk groups.

23. The electronic device according to claim 17, wherein grouping the second preset number of stripes in the storage erasure structure based on the first division rule to obtain different stripe groups comprises:
dividing each of the hard disks based on the second preset number of stripes, and grouping the second preset number of stripes based on the first division rule to obtain different stripe groups.
